(19) United States
(12) Patent Application Publication
(10) Pub. No.: US 2024/0282990 A1
(43) Pub. Date: Aug. 22, 2024

(54) FUEL CELL SYSTEM

(71) Applicant: TOYOTA JIDOSHA KABUSHIKI KAISHA, Toyota-shi (JP)

(72) Inventors: Shigeki HASEGAWA, Toyota-shi (JP); Hiroaki MORI, Ogaki-shi (JP); Tatsuya FUKAMI, Toyota-shi (JP); Kenji SATO, Kasugai-shi (JP)

(73) Assignee: TOYOTA JIDOSHA KABUSHIKI KAISHA, Toyota-shi (JP)

(21) Appl. No.: 18/505,210

(22) Filed: Nov. 9, 2023

(30) Foreign Application Priority Data
Feb. 21, 2023 (JP) 2023-025384

(51) Int. Cl. H01M 8/04537; B60L 58/30

(52) U.S. Cl. CPC H01M 8/04604; B60L 58/30; H01M 2250/20

(57) ABSTRACT

The fuel cell system is provided with an ECU, and the ECU calculates an average value obtained by averaging the instantaneous output values sequentially requested by the fuel cell system in the average calculation time interval during which the fuel cell system operates, and calculates the average value. Each time the average value is calculated, the average value is sequentially set to the output value output by the fuel cell up to the next predetermined cycle, and each time the average value is calculated, the predetermined cycle is added to the average calculation time interval, and the fuel cell system The difference between the instantaneous output value and the output value of the fuel cell is compensated for by the output value due to the discharge of the battery.

### CROSS-REFERENCE TO RELATED APPLICATION

This application claims priority to Japanese Patent Application No. 2023-025384 filed on Feb. 21, 2023, incorporated herein by reference in its entirety.

### BACKGROUND

### 1. Technical Field

The present disclosure relates to a fuel cell system.

### 2. Description of Related Art

Japanese Unexamined Patent Application Publication No. 2002-218606 (JP 2002-218606 A) discloses a technique of calculating a time average value of electric load values to be subjected to power management of a mobile body, and calculating a power generation amount of a fuel cell from the time average value of the electric load values.

### SUMMARY

In JP 2002-218606 A, however, the time for calculating the average value of the electric load values (hereinafter simply referred to as “calculation time”) may not be optimal, and the fuel is not optimal. For example, JP 2002-218606 A has the following problem. When the cycle of the calculation time is too short, the output of the fuel cell is increased or decreased in accordance with short-term fluctuations in the electric load, so that fuel is not optimal. In contrast, when the cycle of the fuel cell is long and the average electric load and the output of the fuel cell are large, the required power cannot be obtained.

The present disclosure has been made in view of the above, and an object of the present disclosure is to provide a fuel cell system in which the fuel of the fuel cell can be optimized.

The present disclosure provides a fuel cell system to solve the above problem and achieve the purpose. A fuel cell system according to the present disclosure includes: a fuel cell that generates electric power using a fuel; a battery that is able to charge and discharge electric power; a drive source driven using the electric power output from at least one of the fuel cell and the battery; and a processor that controls the electric power output by each of the fuel cell and the battery.

The processor calculates, at a predetermined cycle, an average value obtained by averaging instantaneous output values sequentially requested by the fuel cell system in an average calculation time interval during which the fuel cell system operates, each time the average value is calculated, sequentially sets the average value to an output value of the electric power output by the fuel cell up to a subsequent predetermined cycle, each time the average value is calculated, adds the predetermined cycle to the average calculation time interval, and compensates for a difference between each of the instantaneous output values and the output value of the fuel cell with an output value of the electric power discharged by the battery.

The present disclosure produce an effect of optimizing the fuel of the fuel cell.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically showing a vehicle equipped with a fuel cell system according to Embodiment 1;

FIG. 2 is a diagram showing the relationship between the output and thermal efficiency of the fuel cell according to Embodiment 1;

FIG. 3 is a diagram showing the relationship between the instantaneous output value and time in the fuel cell system according to Embodiment 1;

FIG. 4 is a diagram showing the relationship between instantaneous output values, fuel cell, battery, and time in the fuel cell system according to Embodiment 1;

FIG. 5 is a diagram showing the relationship among instantaneous output values, fuel cell, motors, battery, and time in the fuel cell system according to Embodiment 1;

FIG. 6 is a diagram showing an outline of processing of the fuel cell system according to Embodiment 1;

FIG. 7 is a flowchart showing an outline of processing executed by a fuel cell system according to Embodiment 2;

FIG. 8 is a diagram schematically showing transition conditions in mode 1 to mode 3 executed by the fuel cell system according to Embodiment 2; and

FIG. 9 is a diagram showing the relationship between the output value of the fuel cell, the output value of the battery (discharging), the input (charging) of the battery 6, and time according to the second embodiment.

### DETAILED DESCRIPTION OF EMBODIMENTS

A vehicle equipped with a fuel cell system according to an embodiment of the present disclosure will be described below with reference to the drawings. It should be noted that the present disclosure is not limited by the following embodiments. Also, the same parts are denoted by the same reference numerals in the following description.

### Embodiment 1

### Vehicle Overview

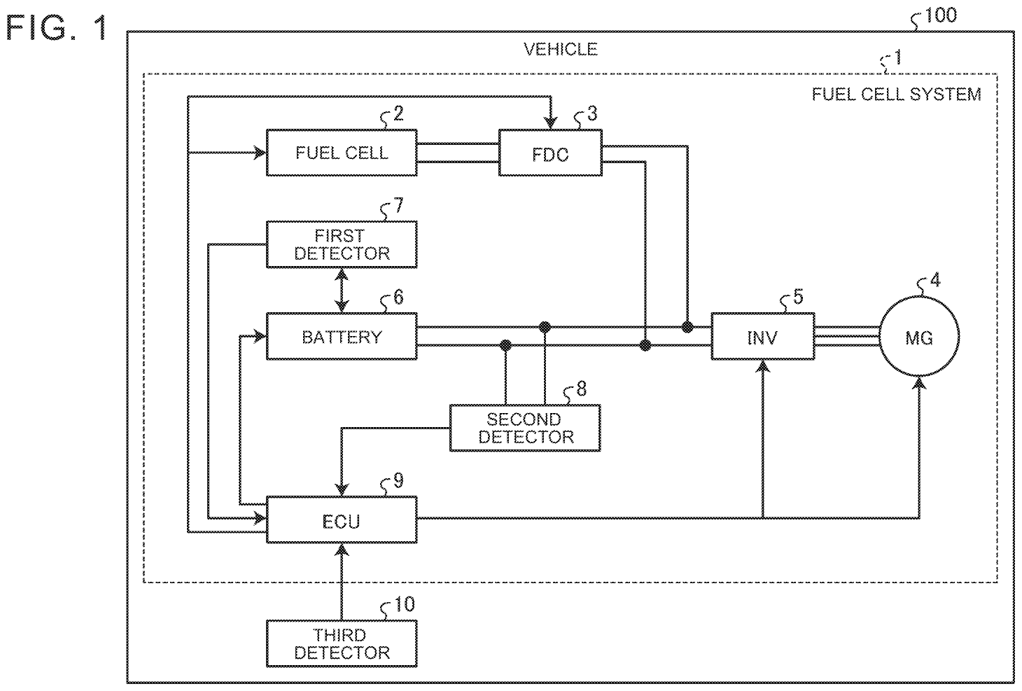

FIG. 1 is a diagram schematically showing a vehicle equipped with a fuel cell system according to Embodiment 1. A fuel cell system 1 shown in FIG. 1 includes a fuel cell 2, a boost converter 3 (hereinafter simply referred to as “FDC 3”), a motor 4, inverter 5 (INV), a battery 6, a first detector 7, a second detector 8, and an electronic control unit (ECU) 9. A fuel cell system 1 is mounted on a vehicle 100.

The vehicle 100 is a fuel cell electric vehicle (FCEV) that drives a motor 4 with electric power generated by the fuel cell 2 and travels with power output from the motor 4.

In the fuel cell system 1, a fuel cell 2 and an FDC 3 are electrically connected. The fuel cell 2 has a plurality of cells (not shown). Under the control of the ECU 9, the fuel cell 2 generates electricity using hydrogen supplied from a hydrogen tank (not shown).

The FDC 3 is a boosting device that boosts and outputs the electric power generated by the fuel cell 2 under the control of the ECU 9. FDC 3 is a DC/DC converter for fuel cell.

The motor 4 is a running motor, and is a motor/generator that functions as an electric motor and a generator. This motor 4 is composed of an AC motor. Motor 4 is electrically connected to fuel cell 2 and FDC 3 and battery 6 via inverter 5. The electric power output from the fuel cell 2 is supplied via the inverter 5 to drive the motor 4 under the control of the ECU 9. Also, the motor 4 is driven by the electric power output from the battery 6 being supplied to the motor 4 via the inverter 5 under the control of the ECU 9.

The inverter 5 is a power conversion device that converts DC power into AC power under the control of the ECU 9 and supplies the AC power to the motor 4. Inverter 5 is electrically connected to motor 4, FDC 3 and battery 6.

The battery 6 is a direct-current power supply and is composed of a secondary battery that stores power to be supplied to the motor 4. Under the control of the ECU 9, the battery 6 supplies power to the motor 4 when the fuel cell 2 cannot generate sufficient power, and stores the power generated by the motor 4 during regeneration. In this case, the power output from the battery 6 is supplied to the motor 4 via the inverter 5, and the power generated by the motor 4 is supplied to the battery 6 via the inverter 5. Also, the battery 6 is electrically connected to the fuel cell 2.

A first detector 7 detects the temperature of the battery 6 and outputs the detection result to the ECU 9. The first detector 7 is configured using a temperature sensor or the like.

A second detector 8 detects the state of charge (SOC), current value, voltage value, and the like of the battery 6 and outputs the detection result to the ECU 9. The second detector 8 is electrically connected in parallel and in series to a connection line connecting the battery 6 and the inverter 5, detects the SOC, current value, and voltage value of the battery 6, and outputs the detection results to the ECU. Output to 9.

The ECU 9 is realized using a processor with hardware. The hard disk is, for example, memory, Central Processing Unit (CPU), Digital Signal Processor (DSP), Field-Programmable Gate Array (FPGA) and Graphics Processing Unit (GPU). The ECU 9 controls each part that configures the fuel cell system 1. The ECU 9 drives and controls the motor based on the detection result of the third detector 10 that detects the access opening. The ECU 9 also controls power generation by the fuel cell 2 and charging/discharging of the battery 6. The ECU 9 calculates an average value obtained by averaging the instantaneous output values sequentially requested by the fuel cell system 1 in the average calculation time interval during which the fuel cell system 1 is operated at a predetermined cycle, and each time the average value is calculated. The average value is sequentially set to the output value A output by the fuel cell up to the next predetermined cycle. After that, every time the ECU 9 calculates the average value, the ECU 9 adds a predetermined cycle to the average calculation time interval, and calculates the difference between the instantaneous output value of the fuel cell system 1 and the output value A of the fuel cell 2 as the output value of the battery 6. Compensate with the output value by discharge.

### Summary of Instantaneous Output Value by Fuel Cell System

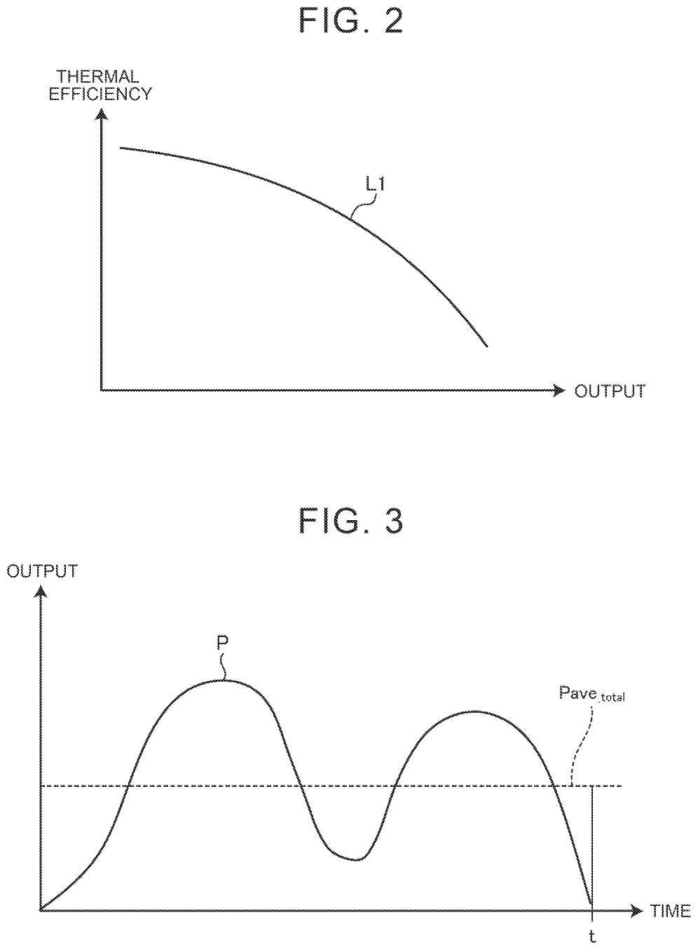

Next, an outline of the instantaneous output value in the fuel cell system 1 will be described. FIG. 2 is a diagram showing the relationship between the output of the fuel cell 2 and thermal efficiency.

As shown by the curve L1 in FIG. 2, the fuel cell 2 becomes less thermally efficient as the load increases. For this reason, the characteristic of the fuel cell 2 is generally an upwardly convex curve (hereinafter simply referred to as “point 1”).

FIG. 3 is a diagram showing the relationship between the instantaneous output value and time in the fuel cell system 1. In FIG. 3, the horizontal axis indicates time, and the vertical axis indicates the output value (instantaneous output value) required by the fuel cell system 1. Further, in FIG. 3, a curve P indicates the instantaneous output value requested by the fuel cell system 1, and a straight line P_{ave_total} indicates the instantaneous output value requested by the fuel cell system 1 over the operating time t (average calculation 20 time interval) of the fuel cell system 1.

The fuel cell 2 has the highest thermal efficiency and fuel efficiency, so starting with point 1, the maximum value of the output value should be reduced. Furthermore, as shown by curve P and straight line P_{ave_total} in FIG. 3, the instantaneous output value and the average output value have the same amount of work at time t. Therefore, when the fuel cell system 1 achieves the same amount of work, and the output value of the fuel cell 2 is the output value A as shown by Point 1 and the curve P and the straight line P_{ave_total} in FIG. 3, the output value A=the average output value (straight line P_{ave_total}) is kept constant (hereinafter simply referred to as “point 2”).

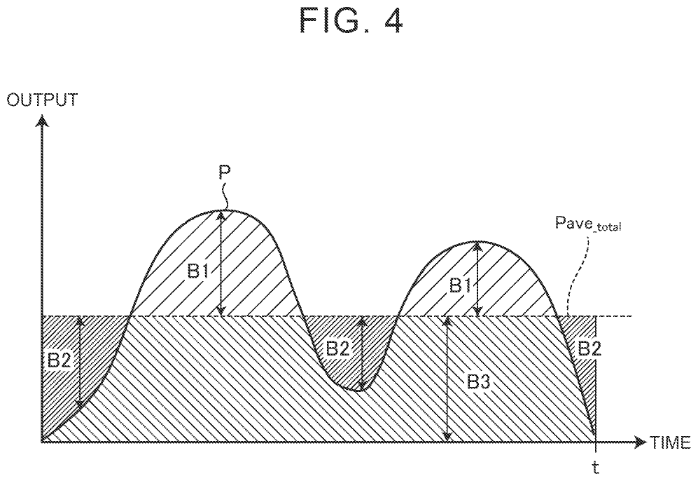

FIG. 4 is a diagram showing the relationship between the instantaneous output value in the fuel cell system 1, the fuel cell 2, the battery 6, and time. In FIG. 4, area B1 is the discharged power of the battery 6 and indicates the amount of work compensated by the battery 6, area B2 indicates the amount of charge of the battery 6 by the fuel cell 2, and area B3 indicates the output of the fuel cell 2. Show value A.

As shown in FIG. 4, in the fuel cell system 1, when the output value A of the fuel cell 2 is the average output value P_{ave_total}, ignoring losses such as charging and discharging of the battery 6, the battery 6 compensates for the area B1. The amount of work done and the amount of charge of the battery 6 by the fuel cell 2 in the region B2 become the same. Therefore, in order to achieve point 2, the fuel cell system 1 compensates for the difference between the instantaneous output value P of the fuel cell system 1 and the output value A (average output value P_{ave_total}) of the fuel cell 2 with the output value of the battery 6 (hereinafter simply referred to as “point 3”).

That is, the ECU 9 controls the fuel cell 2 and the battery 6 so as to compensate for the difference between the instantaneous output value of the fuel cell system 1 and the output value of the fuel cell 2 with the output value resulting from the discharging of the battery 6.

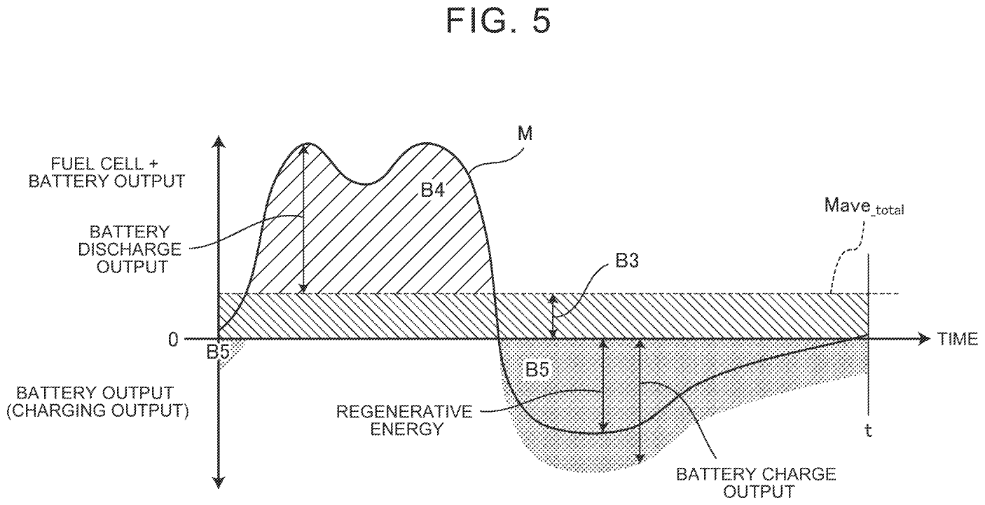

FIG. 5 is a diagram showing the relationship between the instantaneous output value in the fuel cell system 1, the fuel cell 2, the motor 4, the battery 6, and time. In FIG. 5, a region B3 indicates the output value A of the fuel cell 2, a region B4 indicates the discharged power of the battery 6 and the amount of work done by the battery 6, and a region B5 indicates the output value of the fuel cell 2 and the power of the motor 4. The charge amount of the battery 6 by regenerative energy is shown.

As shown in FIG. 5, the motor 4 is responsible for moving the vehicle 100. Therefore, the instantaneous output value P of the fuel cell system 1 can be replaced with the output value M of the motor 4.

As shown in FIG. 5, since the motor 4 regenerates, when the charge side of the battery 6 is represented by a negative value, the highest thermal efficiency and fuel efficiency are obtained when the fuel cell 2 output value A=M_{ave_total} is constant. Further, in the fuel cell system 1, when the output value A of the fuel cell 2 is the average output value M_{ave_total} of the motor 4, the amount of work in the region B4 and the amount of charge in the region B5 are the same. Therefore, the fuel cell system 1 may compensate for the difference between the instantaneous output value of the motor 4 and the output value A of the fuel cell 2 with the output value of the battery 6 (hereinafter simply referred to as “point 3_1”).

However, for the fuel cell system 1, each of the instantaneous output value P or the output value M of the motor 4 and the time t (the operating time during which the fuel cell system 1 operates) that is the running time of the vehicle 100 is unknown before running. Therefore, the fuel cell system 1 cannot set the output value A of the fuel cell 2 because the average output value P_{ave_total} is also unknown. In particular, when the vehicle 100 is a commercial vehicle, the output value M of the motor 4 changes greatly when the load is different.

For this reason, the ECU 9 calculates the average value of the instantaneous output values sequentially requested by the fuel cell system 1 in the average calculation time interval during which the fuel cell system 1 operates, and calculates the average value in a predetermined cycle. Each time, the average value is sequentially set to the output value A output by the fuel cell up to the next predetermined cycle. After that, every time the ECU 9 calculates the average value, the ECU 9 adds a predetermined cycle to the average calculation time interval, and calculates the difference between the instantaneous output value of the fuel cell system 1 and the output value A of the fuel cell 2 as the output value of the battery 6. Compensate with the output value by discharge.

### Processing by Fuel Cell System 1

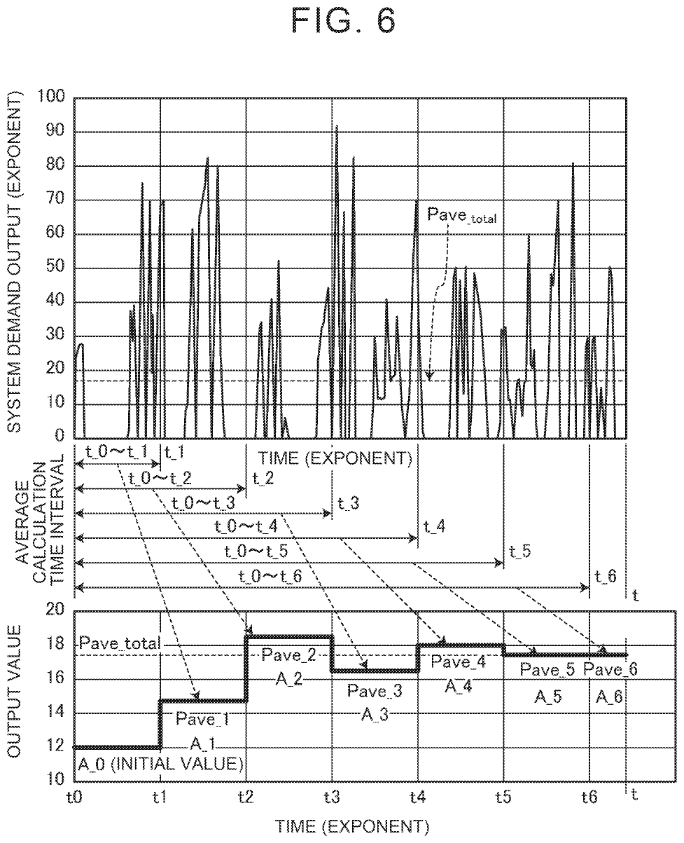

Next, processing by the fuel cell system 1 will be described. FIG. 6 is a diagram showing an overview of the processing of the fuel cell system 1. In FIG. 6, the upper side shows the relationship between the required output of the fuel cell system 1 and time, and the lower side shows the relationship between the FC output target value (index) of the fuel cell 2 and time (index). In FIG. 6, the time on the upper side and the time on the lower side correspond to each other. Furthermore, in FIG. 6, the output value of the fuel cell 2 is set to the output value A_{_0} as an initial value.

As shown in FIG. 6, the ECU 9 first calculates the average output value P_{ave_n} obtained by averaging the instantaneous output value P of the fuel cell system 1 over the average calculation time interval t_{_0} to t_{_n} of a predetermined cycle, A target output value A_{_n} of the fuel cell 2 during the average calculation time interval t_{_n} to t_{_n+1} is assumed.

Specifically, as shown in FIG. 6, the ECU 9 calculates the average output value P_{ave_1} obtained by averaging the instantaneous output values P of the fuel cell system 1 over the average calculation time interval t_{_0} to t_{_1}, which is the next period. A target output value A_{_1} of the fuel cell 2 during the average calculation time interval t_{_n} to t_{_2} is calculated and set. In this case, the ECU 9 controls the power generation of the fuel cell 2 so that the output value of the power generation of the fuel cell 2 becomes the output value A_{_1}.

Subsequently, the ECU 9 converts the average output value P_{ave_n+1} averaged in the average calculation time interval t_{_0} to t_{_n+1} obtained by adding the next cycle to the fuel output value P_{ave_n+1} during the average calculation time interval t_{_n+1} to t_{_n+2}, which is the next cycle. Assume that the target output value of the fuel cell 2 is A_{_n+1}.

Specifically, as shown in FIG. 6, the ECU 9 calculates the average output value P_{ave_2} averaged over the averaging calculation time interval t_{_0} to t_{_2} to which the next cycle is added as a target output value A_{_n+1} of the fuel cell 2 at the time of average calculation time interval t_{_2} to t_{_3} that is the next cycle. In this case, the ECU 9 controls the power generation of the fuel cell 2 so that the output value of the power generation of the fuel cell 2 becomes the output value A_{_2}. At this time, the ECU 9 calculates the difference between the output value of the fuel cell 2 and the instantaneous output value required by the fuel cell system 1, and control the discharge of the battery 6 so as to compensate for the calculated difference with the output value (discharge) resulting from the discharge of the battery 6.

As a result, as indicated by the straight line P_{ave_total} in FIG. 6, the output value A of the fuel cell 2 gradually approaches the average output value P_{ave_total} as the average calculation section time lengthens with the passage of time. As a result, the fuel of the fuel cell 2 becomes the best.

Here, an example of a trial calculation method for the average output value Pₐᵥₑ calculated by the ECU 9 and the Mₐᵥₑ of the motor 4 will be described.

### Trial Calculation Method 1

The method of calculating the average output value Pₐᵥₑ of the fuel cell 2 and the Mₐᵥₑ of the motor 4 is based on the average calculation time interval, the instantaneous output value required by the fuel cell system 1 in the average calculation time interval, the current output value of the motor 4 (discharge) and the average value of the input value (charging) of the motor 4 (calculation method 1). In this case, the ECU 9 acquires the detection result detected by the second detector 8, and based on the acquired detection result, the instantaneous output value requested by the fuel cell system 1 in the average calculation time interval, the current of the motor 4 and the input value (charging) of the motor 4 are calculated. After that, the ECU 9 averages the instantaneous output value requested by the fuel cell system 1, the current output value (discharge) of the motor 4, and the input value (charge) of the motor 4 during the average calculation time interval. The average value obtained is calculated as the average output value Pₐᵥₑ.

### Trial Calculation Method 2

Another trial calculation method for the average output value Pₐᵥₑ of the fuel cell 2 and the Mₐᵥₑ of the motor 4 is the fluctuation of the SOC of the battery 6 before and after the averaging calculation time interval elapses, and the output of the fuel cell 2 during the average calculation time interval. It may be calculated with the value A (calculation method 2).

Specifically, the ECU 9 calculates the average output value Pₐᵥₑ of the fuel cell 2 and the Mₐᵥₑ of the motor 4 using the following equation (1) or (2).

$${P}_{ave \_ n} = output value {A}_{\_ n - 1} - capacity of battery 6 \times ( S O {C}_{\_ n} - S O {C}_{\_ 0} ) \div average calculation time \times k ( correction coefficient ) \qquad ( 1 )$$

$${M}_{ave \_ n} = output value {A}_{\_n - 1} - capacity of battery 6 \times ( S O {C}_{\_ n} - S O {C}_{\_ 0} ) \div average calculation time \times k ( correction coefficient ) \qquad ( 2 )$$

Note that k is a value for correcting charge/discharge loss, boost converter loss, or the like.

Also, the interval of the cycle to be added to the average calculation time interval can be changed as appropriate, and may be set arbitrarily by the user, may be a fixed value, or may be set so that the interval gradually increases.

Further, the ECU 9 calculates the difference between the current value of the SOC of the battery 6 and the target value of the SOC of the battery 6, and when this difference becomes equal to or greater than a specified value, the output value A of the fuel cell 2 is changed to the Power generation may be increased or decreased so as to bring the SOC closer of the battery 6 to the target value. For example, when the current SOC value of the battery 6 is equal to or higher than the target value, the ECU 9 performs control to decrease the output value A of the fuel cell 2. Control is performed to increase the output value A of the fuel cell 2. Specifically, when performing control to decrease the output value A of the fuel cell 2, the ECU 9 calculates the output value A_{_n} of the fuel cell 2 by the following equation (3), while calculating the output value A_{_n} of the fuel cell 2 When performing control to increase A, the output value A_{_n} of the fuel cell 2 is calculated by the following equation (4).

$$Output value {A}_{\_ n} = Output value {A}_{\_ n - 1} - capacity of battery 6 \times ( S O {C}_{\_ n} - S O {C}_{\_ 0} ) \div average calculation time \times k ( correction coefficient ) + α ( S O C adjustment value ) \qquad ( 3 )$$

$$Output value {A}_{\_ n} = Output value {A}_{\_ n - 1} - capacity of battery 6 \times ( S O {C}_{\_ target value} - S O {C}_{\_ 0} ) \div average calculation time \times k ( correction coefficient ) \qquad ( 4 )$$

Further, the ECU 9 may hold the last output value A of the fuel cell 2 at the previous trip of the vehicle 100 and use it as an initial value for the next trip of the vehicle 100. As a result, the fuel cell 2 can be operated with the output value A close to the optimum fuel consumption from the beginning.

Further, the ECU 9 separately calculates the initial value of the output value A of the fuel cell 2 in advance based on the travel route set for the vehicle 100 and the load amount loaded on the vehicle 100, and this calculation An initial value of the output value A may be set.

According to the first embodiment described above, the ECU 9 calculates the difference between the output value of the fuel cell 2 and the instantaneous output value requested by the fuel cell system 1, and converts the calculated difference to the output value of the discharged battery 6. Control the battery 6 to compensate for (discharge). As a result, the output value A of the fuel cell 2 gradually approaches the average output value P_{ave_total} over time as the length of the average calculation interval lengthens, so the fuel of the fuel cell 2 becomes the best.

### Embodiment 2

Next, Embodiment 2 will be described. In the first embodiment, there is only one mode, but in the second embodiment, a plurality of modes are provided, and the mode is switched to one of the plurality of modes according to the fuel cell 2, the battery 6, and the accelerator operation amount. Note that the fuel cell system according to Embodiment 2 has the same configuration as the fuel cell system 1 according to Embodiment 1, and the processing executed by the ECU is different. Processing executed by the ECU included in the fuel cell system according to the second embodiment will be described below.

### Processing of Fuel Cell System 1

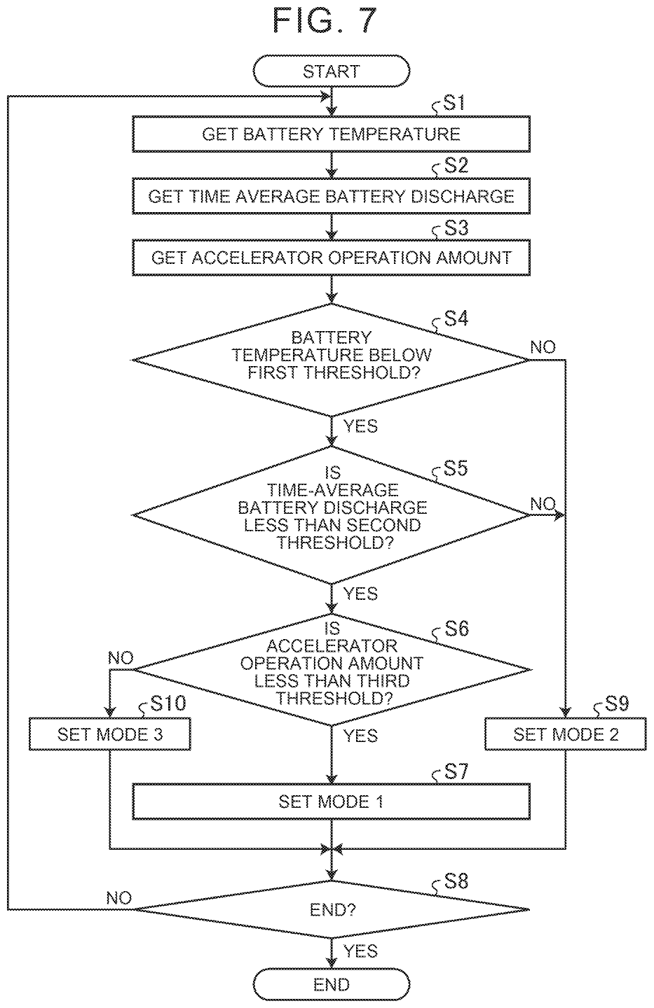

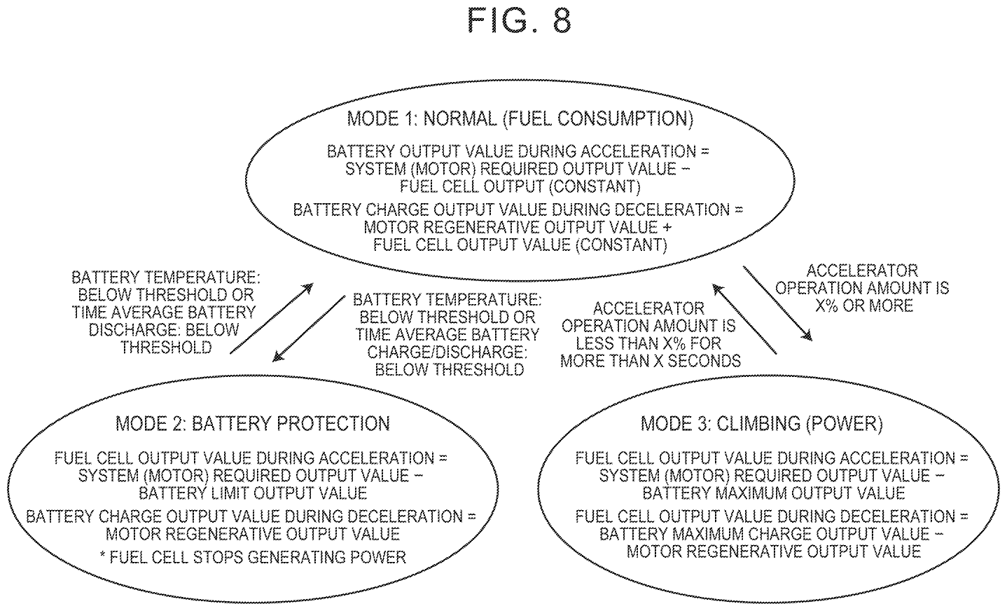

FIG. 7 is a flowchart showing an overview of the process executed by the fuel cell system 1. FIG. 8 is a diagram schematically showing transition conditions in mode 1 to mode 3 executed by the fuel cell system 1.

As shown in FIG. 7, first, the ECU 9 acquires the battery temperature of the battery 6 detected by the first detector 7 (S1), and the time average battery discharge of the battery 6 detected by the second detector 8 is calculated. Amount is acquired (S2).

Subsequently, the ECU 9 acquires the accelerator operation amount with which the user presses the accelerator pedal, which is detected by the third detector 10 (S3).

Thereafter, when the battery temperature is less than the first threshold (S4: Yes) and the time average battery discharge is less than the second threshold (S5: Yes), the ECU 9 determines whether the access opening degree is less than the third threshold (S6: Yes), the fuel cell system 1 is set and controlled in mode 1 (normal (control similar to that of the first embodiment)) (S7). In this case, the ECU 9 controls each of the fuel cell 2 and the battery 6 such that the output value of the battery 6 becomes a value obtained by subtracting the output value A_{_n} (constant) of the fuel cell 2 from the required output value of the fuel cell system 1 (motor 4) when the vehicle 100 is accelerating (output value of battery 6=required output value of fuel cell system 1−output value A_{_n} (constant) of fuel cell 2). In addition, the ECU 9 controls the fuel cell 2 so that the charge output value of the battery 6 becomes a value obtained by adding the output value of the regenerative energy of the motor 4 and the output value A_{_n} (constant) of the fuel cell 2 when the vehicle 100 decelerates, and the battery 6 (charging output value of battery 6=output value by regenerative energy of motor 4+output value A_{_n} of fuel cell 2 (constant). Note that the first threshold, the second threshold, and the third threshold can be set as appropriate.

Subsequently, the ECU 9 determines whether or not an instruction signal to turn off the power has been input from the injection switch (S8). If the ECU 9 determines that an instruction signal to turn off the power has been input from the injection switch (S8: Yes), the fuel cell system 1 terminates this process. On the other hand, if the command signal to turn off the power is not input from the injection switch by the ECU 9 (S8: No), the fuel cell system 1 returns to S1.

In S4, if the battery temperature is not less than the first threshold (S4: No), or if the battery temperature is less than the first threshold (S4: Yes), and the time average battery discharge is less than the second threshold If not less than (S5: No), the fuel cell system 1 is set to mode 2 (battery protection mode) and controlled (S9). After S9, the fuel cell system 1 proceeds to S8.

Mode 2 (battery protection mode) will now be described.

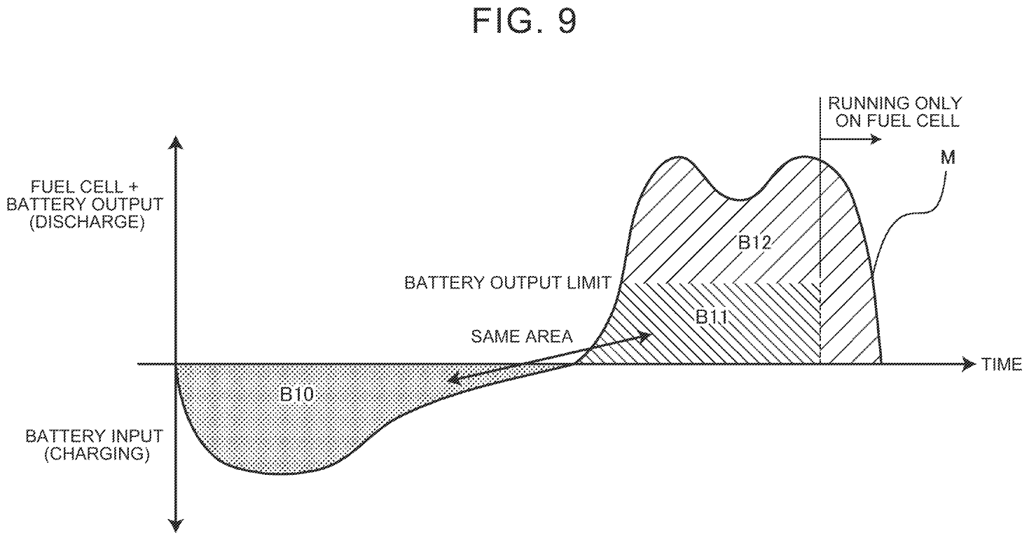

FIG. 9 is a diagram showing the relationship between the output value of the fuel cell 2, the output value (discharge) of the battery 6, the input (charge) of the battery 6, and time. In FIG. 6, the horizontal axis indicates time, the positive vertical axis indicates the output value of the fuel cell 2 and the output value of the battery 6, and the negative indicates the input (charging) of the battery 6. In FIG. 9, a region B10 indicates the input value of the battery 6 by regenerative energy of the motor 4, a region B11 indicates the output value of the battery 6, and a region B12 indicates the output value of the fuel cell 2.

When the average output value P_{ave_total} of the output value of the fuel cell 2 is larger than the output value of the motor 4 (motor output value<A: average output value P_{ave_total}), the ECU 9 suppresses or stops the output of the fuel cell 2, control is performed as mode 2. In this case, the ECU 9 controls the amount of charge from the fuel cell 2 to the battery 6 or stops charging, and uses regenerative energy from the motor 4 to charge the battery 6.

In this case, the ECU 9 controls the discharge output of the battery 6, as shown in FIG. 9. Specifically, the ECU 9 sets the discharge amount of the battery 6 to the amount stored by the regenerated energy from the motor 4 (see area B10 and area B11). That is, the ECU 9 gradually decreases the power generation output value of the fuel cell 2 based on the battery temperature detected by the first detector 7 and stops charging the battery 6 from the fuel cell 2. In this case, the ECU 9 controls the current value and the voltage value detected by the second detector 8 in order to prevent temperature rise due to heat generated by the internal resistance of the battery 6 or deterioration of the battery 6 due to the use of high-rate discharge, the ion concentration of the battery 6 may be estimated, and control may be performed such that the power generation output value of the fuel cell 2 is reduced stepwise based on this estimation result.

Further, in the case of mode 2, since the output and discharge amount of the battery 6 is restricted, the ECU 9 drives the fuel cell 2 such that, when the battery 6 cannot supply enough electric power to match the output of the motor 4, the fuel cell 2 compensates for the shortage of the battery 6. Specifically, as shown in FIG. 9, when the battery 6 cannot supply the electric power corresponding to the output of the motor 4 corresponding to the instantaneous output value P of the fuel cell system 1, the ECU 9 causes the fuel cell 2 to The fuel cell 2 is driven so as to compensate for the shortage of 6 (see area B11 and area B12).

As a result, the fuel cell system 1 can maximize the regenerative energy from the motor 4 while minimizing the effect on fuel consumption. Furthermore, the fuel cell system 1 can eliminate the heat generation of the battery 6 and the imbalance of ions in a short period of time without reducing the SOC of the battery 6.

Further, when suppressing power generation of the fuel cell 2, the ECU 9 records the SOC of the battery 6 based on the detection result detected by the second detector 8, and controls the fuel cell 2 so that the value of this SOC does not fall below power generation is controlled. In this case, the ECU 9 controls to stop discharging the battery 6 when the SOC value of the battery 6 becomes less than the second threshold value.

In S6, if the accelerator operation amount is not less than the third threshold (S6: No), the fuel cell system 1 is set to mode 3 (uphill (power)) and controlled (S10). In this case, the ECU 9 fuel cell such that the output value A_{_n} of the fuel cell 2 becomes a value obtained by subtracting the maximum output value of the battery 6 from the required output value of the fuel cell system 1 (motor 4) when the vehicle 100 is accelerating. Each of the fuel cell 2 and the battery 6 is controlled (output value A_{_n} (constant) of the fuel cell 2=required output value of the fuel cell system 1−maximum output value of the battery 6). Further, the ECU 9 controls the fuel cell 2 and the fuel cell so that the output value A_{_n} of the fuel cell 2 becomes a value obtained by subtracting the output value due to the regenerative energy of the motor 4 from the maximum charge output value of the battery 6 when the vehicle 100 is subtracted. 6 (output value A_{_n} (constant) of fuel cell 2=maximum charge value of battery 6−output value by regenerative energy of motor 4). That is, the longer the output value A of the fuel cell 2 stays constant, the higher the effect of improving fuel cell efficiency, but when a high required output value is required by the fuel cell system 1 (motor 4) at the time of climbing a slope, abrupt acceleration, and the like and the battery 6 cannot be charged or discharged sufficiently, the vehicle 100 can be smoothly accelerated by temporarily varying the output value A of the fuel cell 2. After S10, the fuel cell system 1 proceeds to S8.

According to the second embodiment described above, when the output value A output by the fuel cell 2 is higher than the output value by the regenerative energy of the motor 4, the ECU 9 suppresses the output value A output by the fuel cell 2, or Since the output of the fuel cell 2 is stopped, the deterioration of the battery 6 and the reduction of the SOC of the battery 6 can be prevented, and the fuel consumption can be improved.

Further, according to the second embodiment, the ECU 9 discharges the output value discharged by the battery 6 by the electric power charged according to the output value of the regenerative energy of the motor 4. Therefore, while maximizing the regenerative energy, the influence on fuel consumption can be minimized.

Further, according to the second embodiment, when the ECU 9 determines that the temperature of the battery 6 is not less than the first threshold, the ECU 9 controls the fuel cell 2 and the battery 6 by changing the mode from mode 1 in which the difference between the instantaneous output value of the fuel cell system 1 and the output value of the fuel cell 2 is compensated for with the output by the battery 6 to mode 2 in which the output value of the fuel cell 2 is suppressed or the output of the fuel cell 2 is stopped. Therefore, fuel efficiency can be improved while preventing deterioration of the battery 6.

Further, according to the second embodiment, when the ECU 9 determines that the accelerator operation amount is not less than the third threshold, the difference between the instantaneous output value of the fuel cell system 1 and the output value of the fuel cell 2 is mode 1 compensates for the output from 6 to mode 3 corresponding to the instantaneous output value of the fuel cell system 1 by adding the output value output by the fuel cell 2 and the output value for discharging the battery 6 to the maximum. Since the fuel cell 2 and the battery 6 are controlled, the vehicle 100 can be smoothly accelerated even when climbing a slope.

### Other Embodiments

In the fuel cell systems according to Embodiments 1 and 2, the “unit” described above can be read as “means” or “circuit”. For example, the first detector can be read as first detection means or a first detection circuit.

Further, the program to be executed by the fuel cell system according to the first and second embodiments can be stored as file data in an installable format or an executable format on a CD-ROM, a flexible disk (FD), a CD-R, a Digital Versatile Disk (DVD), a USB medium, a flash memory, or other computer-readable recording medium.

In addition, in the description of the flowchart in this specification, expressions such as “first”, “after”, and “following” are used to clearly indicate the anteroposterior relationship of the processing between steps. The order of processing required to do so is not uniquely determined by those representations. That is, the order of processing in the flowchart charts described herein may be changed within a consistent range.

Further effects and modifications can be easily derived by those skilled in the art. The broader aspects of the disclosure are not limited to the specific details and representative embodiments shown and described above. Accordingly, various changes may be made without departing from the spirit or scope of the general inventive concept defined by the appended claims and equivalents thereof.

As described above, some of the embodiments of the present application have been described in detail with reference to the drawings. These are examples, and it is possible to carry out, in addition to the aspect described in the SUMMARY section, the present disclosure in other forms with modifications and improvements based on the knowledge of a person skilled in the art.

What is claimed is:

1. A fuel cell system comprising:
a fuel cell that generates electric power using a fuel;
a battery that is able to charge and discharge electric power;
a drive source driven using the electric power output from at least one of the fuel cell and the battery; and
a processor that controls the electric power output by each of the fuel cell and the battery, wherein the processor
calculates, at a predetermined cycle, an average value obtained by averaging instantaneous output values sequentially requested by the fuel cell system in an average calculation time interval during which the fuel cell system operates,
each time the average value is calculated, sequentially sets the average value to an output value of the electric power output by the fuel cell up to a subsequent predetermined cycle,
each time the average value is calculated, adds the predetermined cycle to the average calculation time interval, and
compensates for a difference between each of the instantaneous output values and the output value of the fuel cell with an output value of the electric power discharged by the battery.

2. The fuel cell system according to claim 1, wherein:
the drive source is a motor; and
the processor suppresses the output value of the electric power output from the fuel cell or stops an output from the fuel cell, when the output value of the electric power output from the fuel cell is higher than an output value resulting from regenerative energy of the motor.

3. The fuel cell system according to claim 2, wherein the processor causes the battery to discharge the electric power by an amount of the electric power charged in accordance with the output value resulting from the regenerative energy of the motor.

4. The fuel cell system according to claim 3, wherein the processor
obtains a temperature of the battery,
determines whether the temperature of the battery is less than a predetermined value, and
when the processor determines that the temperature of the battery is not less than the predetermined value, changes a mode from a first mode to a second mode to control the fuel cell and the battery, the first mode being the mode in which the processor compensates for the difference between each of the instantaneous output values and the output value of the fuel cell with an output from the battery, the second mode being the mode in which the processor suppresses the output value of the electric power output from the fuel cell or stops the output from the fuel cell.

5. The fuel cell system according to claim 4, wherein the processor
acquires an accelerator operation amount,
determines whether the accelerator operation amount is less than a predetermined value, and
when it is determined that the accelerator operation amount is not less than the predetermined value, changes the mode from the first mode to a third mode to control the fuel cell and the battery, the first mode being the mode in which the processor compensates for the difference between each of the instantaneous output values and the output value of the fuel cell with the output from the battery, the third mode being the mode in which each of the instantaneous output values is supported using a value obtained by adding the output value of the electric power output from the fuel cell to the output value of the battery when the battery discharges at a maximum electric power.
